(19) United States
(12) Patent Application Publication
(10) Pub. No.: US 2025/0304052 A1
(43) Pub. Date: Oct. 2, 2025

(54) Vehicle safety and/or driver assistance method, arrangement and data processing program product using connectable road vehicle image capturing system

(71) Applicant: MOTHERSON INNOVATIONS COMPANY LIMITED, London (GB)

(72) Inventor: Romeo Wieczorek, Esslingen am Neckar (DE)

(21) Appl. No.: 19/092,682

(22) Filed: Mar. 27, 2025

(30) Foreign Application Priority Data
Mar. 28, 2024 (DE) 102024109094.4

(51) Int. Cl. B60W 30/09; B60R 1/26; B60W 30/16; B60W 30/18; B60W 50/14; G06V 10/82; G06V 20/58; H04W 4/46

(52) U.S. Cl. CPC B60W 30/09; B60R 1/26; B60W 30/16; B60W 30/18163; B60W 50/14; G06V 10/82; G06V 20/582; H04W 4/46; B60R 2300/303; B60W 2050/146; B60W 2420/403; B60W 2520/10; B60W 2554/802; B60W 2555/60; B60W 2556/40; B60W 2556/65

(57) ABSTRACT

A vehicle safety and/or driver assistance method, arrangement and data processing program product using a first image capturing system having a first field of view, adapted for detecting speed data, generating first field of view depth data and/or object detection distance data, using an artificial intelligence algorithm, evaluating, if a minimum field of view depth criteria and/or minimum object distance safety criteria is fulfilled, in case the minimum field of view depth criteria and/or the minimum object distance safety criteria is not fulfilled, combining first and second image capturing system image data to create a combined image data, evaluating if a minimum field of view depth criteria and/or minimum object distance safety criteria is fulfilled, and outputting and/or displaying safety data, the safety data being indicative if performing a certain vehicle maneuver is safe.

### CROSS-REFERENCE TO RELATED APPLICATION(S)

This application claims the benefit of German Patent Application No. 102024109094.4, filed Mar. 28, 2024, the content of which is hereby incorporated by reference in its entirety.

### FIELD OF THE INVENTION

The present invention relates to a vehicle safety and/or driver assistance method, arrangement and data processing program product using connectable road vehicle image capturing systems, in particular using connectable rear view systems, in particular using connectable camera-based rear view systems, in particular for virtually extending the field of view of such image capturing systems for object detection, in particular in case of limitations of the field of view of at least one image capturing system.

### TECHNICAL BACKGROUND

U.S. Pat. No. 10,501,015 B2 discloses an extended view method and apparatus, the method including generating a virtual viewpoint image of a vehicle based on a surrounding view of the vehicle, generating an extended virtual viewpoint image based on the virtual viewpoint image of the vehicle and a received virtual viewpoint image of another vehicle, and displaying the extended virtual viewpoint image to a user. One embodiment in this document provides a surround viewing method, the method comprising: generating, by a vehicle, a first image of the vehicle based on a surrounding image of the vehicle; receiving a second image generated by another vehicle on a road; determining a location relationship between the vehicle and the another vehicle; generating an extended image using the first image and the second image; and outputting the generated extended image, wherein the generating of the extended image comprises: selecting, based on the location relationship, an overlapping area that appears in both the first image and the second image, and generating the extended image to include the overlapping area. Another embodiment in this document provides a surround viewing apparatus, the apparatus comprising: an image generator configured to generate a first image of a vehicle based on a surrounding image of the vehicle; a receiver configured to receive a second image generated by another vehicle on a road; and an extended image generator configured to determine a location relationship between the vehicle and the another vehicle; create an extended image using the first image and the second image, select, based on the location relationship, an overlapping area that appears in both the first image and the second image, and generate the extended image to include the overlapping area; and a display configured to display the generated extended image.

Vehicles, in particular road vehicles, are required to have exterior rear view systems, which allow the driver to observe the surroundings of the vehicle, which are outside of the driver's peripheral vision. In order to enable the driver to observe the surroundings, the exterior rear view systems are mounted to the exterior of road vehicles. The surroundings of the vehicle include the rear of the vehicle as well as the left and right side of the vehicle. Furthermore, some exterior rear view systems are configured to effectively cover the blind spot(s) of the driver.

Exterior rear view systems usually employ some sort of reflective surface, in particular mirror, or a camera system. Furthermore, exterior rear view systems, especially systems for housing a camera system, are configured to be attached to a vehicle body and carry a multitude of connectors, sensors and/or actuators in order to ensure a proper functionality.

A rear view device for a motor vehicle provides an image of the rear part of the motor vehicle which at least meets the legal requirements and belongs to a subgroup of devices for indirect vision. These provide images and views of objects which are not in the direct field of vision of a driver, i.e. in directions opposite, left, right, below and/or above the driver's line of vision. The driver's view may not be fully satisfactory, in particular in the direction of vision. For example, there may be obstructions to vision caused by parts of the driver's own vehicle, such as parts of the carriage, in particular the A-pillar, the roof structure and/or the bonnet, and obstructions to vision caused by other vehicles and/or objects outside the vehicle which may obstruct vision in such a way that the driver cannot fully satisfactorily grasp a driving situation or can only grasp it incompletely. In addition, the driver may not be able to perceive the situation presented to him in or away from the line of vision in the way that would be necessary to control the vehicle according to the situation. Therefore, a rear view device may also be designed to process the information according to the driver's abilities in order to give him the best possible understanding of the situation.

Various functions and devices may be incorporated in and/or controlled by rear view devices, including in particular cameras. Particularly useful are functions and devices for improving, extending and/or maintaining the functionality of the rear view device under normal or extreme conditions. This can include heating and/or cooling arrangements, cleaning arrangements such as wipers, actuators for moving the rear view device or parts thereof, such as a display, a camera system and/or parts of a camera system comprising for example lenses, filters, light sources, adaptive optics such as deformable mirrors, sensors and/or mirrors, and/or actuators for inducing movements of other objects, for example parts of the vehicle and/or objects surrounding the vehicle.

The camera may include, for example, one or several CCD or CMOS sensors. The housing of a camera module may be made of plastic, metal, glass, another suitable material and/or any combination thereof and may be used in combination with the techniques described below to change or modify the properties of the material or the material surface. Various types of fastening arrangements can be used to attach the camera module to the vehicle or other components, such as positively form-fit connecting arrangements and/or non-positively force-fit connecting arrangements.

A person skilled in the art can find more details and references on how to implement one or several of afore mentioned technical features e.g. in previous patent application document U.S. Pat. No. 11,014,490 B2 filed by the same patent applicant being applicant of this patent application, hereby incorporated by reference into the disclosure of this patent application. The individual features of this earlier patent application, filed by the patent applicant of this patent application, are hereby incorporated by reference into the specification of this invention, where and in so-far those of ordinary skill in the art may find it useful that such individual features of this earlier patent application are combined with the features of the invention disclosed herein and/or used to practice the invention disclosed herein.

In the previous patent application US 2019/318178 A1 filed by the same patent applicant being applicant of this patent application, and hereby incorporated by reference into the disclosure of this patent application, a person skilled in the art can find more details and references on how to implement a method for obtaining 3D information of objects shown in at least two images, as well as a device for carrying out the respective steps of the method and a system including such a device, for implementation in a vehicle including such a device or such a system. In particular, in the context of the afore mentioned document as well as in the context of the invention, images may be obtained by at least two on-vehicle image sensors.

In cases where several or multiple image sensors are not available, an artificial intelligence (AI) algorithm can be applied in the context of the invention to detect objects and/or distances from 2D images or video sequences. Deep learning models, such as convolutional neural networks (CNNs), can be trained to recognize and estimate distances to objects based on visual characteristics like size, shape, perspective and/or texture. Such deep learning models can be designed to automatically learn hierarchical representations of features in images. During a training phase, the deep learning model is exposed to labeled dataset. The model learns to identify patterns, textures, shapes, and features within images that are relevant to the task. It adjusts its internal parameters (weights and biases) through a process called backpropagation and optimization techniques like gradient descent. An alternative approach is learning based on data that is not labelled, such as zero-shot learning AI algorithms. A zero-shot learning AI algorithm can be applied for object detection and distance detection by using a pre-trained language model and a neural network architecture to generate descriptions of objects and estimate their distances. The pre-trained language model can automatically generate descriptions of objects based on their visual features, such as size, shape, perspective, and/or texture. The neural network can then use these descriptions to detect and classify objects, as well as distances to objects. The pre-trained language model can generate descriptions of distances to objects and the neural network can use these descriptions to estimate the distance to such detected objects. This means that AI models trained based on labelled datasets and/or trained based on zero-shot learning can be applied for object and distance detection to generate descriptions of objects and estimate their distances.

An artificial intelligence algorithm applicable for use in the context of the invention can be designed to include a generative pre-trained transformer that uses special algorithms to find patterns in data sequences, in particular in image data representing images captured by one or several vehicle on-board image capturing systems and/or in image data representing sequences of images captured by one or several vehicle on-board image capturing systems. Therefore, such AI algorithm applicable for use in the course of the invention can comprise a machine learning model in the form of a neural network, in particular in particular in the form of a transversal neural network and/or in the form of a convolutional neural network, correlated with a generative pre-trained transformer.

An artificial intelligence algorithm applicable for use in the context of the invention can be designed to include a generative transversal neural network (TNN) algorithm, module or method. The transversal neural network (TNN) algorithm, module or method can be used to determine the distance of an object in a camera image. Transversal neural networks are special neural network architectures developed to model spatial information and solve tasks such as distance determination or depth perception. A person skilled in the art can find more details and references on how to implement a generative transversal neural network (TNN) algorithm, module or method in the following prior art document, hereby incorporated by reference into the disclosure of this patent application:
Koch, T., Liebel, L., Fraundorfer, F., Körner, M. (2019). Evaluation of CNN-Based Single-Image Depth Estimation Methods. In: Leal-Taixé, L., Roth, S. (eds) Computer Vision—ECCV 2018 Workshops. ECCV 2018. Lecture Notes in Computer Science( ), vol 11131. Springer, Cham., https://doi.org/10.1007/978-3-030-11015-4_25

There are several approaches on how a transversal neural network (TNN) algorithm, module or method can be used for distance estimation. One commonly used method is the use of so-called depth estimation networks based on a transversal neural network (TNN) algorithm, module or method. These networks are trained with large amounts of coupled images and depth information to capture the spatial relationships between pixels.

The depth estimation network uses a camera image as input and generates a corresponding image of depth information as output. By analyzing the spatial features and patterns in the images, they can estimate distance data, i.e. how far away the objects in the image are from the image capturing device that has captured the initial image.

A person skilled in the art can use one of or parts of or a combination of the afore mentioned artificial intelligence algorithms, modules or methods in the context of the invention as described in this document.

### SUMMARY OF THE INVENTION

In view of the above, an object of the present invention is to provide a new and improved vehicle safety and/or driver assistance method, arrangement and data processing program product using a road vehicle image capturing system, in particular using image capturing systems connectable by wireless data connection, in particular using one—in particular camera-based—rear view system or a plurality of—in particular camera-based—rear view systems, in particular for virtually extending the field of view of such image capturing system for object detection, in particular in case of limitations of the field of view of said image capturing system, such as limitations caused by technical limitations, distances or visual obstructions.

In accordance with the present invention, the following is provided:
a vehicle safety and/or driver assistance method, using a first image capturing system having a first field of view, as recited in claim 1;
a vehicle safety and/or driver assistance method, using image data from data connected—in particular camera-based—image capturing systems mounted to at least one vehicle as recited in claim 2;
a vehicle safety and/or driver assistance method, using a first—in particular camera-based—rear view image capturing system having a first field of view as recited in claim 9;
a vehicle safety and/or driver assistance arrangement, in particular adapted to implement a previously mentioned method, as recited in claim 10 and/or claim 11 respectively;
a data processing program product, adapted for implementing a vehicle safety and/or driver assistance method and adapted to implement a previously mentioned method, in particular in a previously mentioned arrangement, in particular a data processing program product, adapted for implementing a vehicle safety and/or driver assistance method using a first image capturing system, as recited in claim 15;
a data processing program product, adapted for implementing a vehicle safety and/or driver assistance method using a using a first—in particular camera-based—rear view image capturing system as recited in claim 16; and
a data structure for use in a vehicle safety and/or driver assistance arrangement and/or for use in a vehicle safety and/or driver assistance method as recited in claim 17.

Advantageous or preferred features of the invention are recited in the dependent claims.

According to a first aspect, the present invention provides a vehicle safety and/or driver assistance method, using a first image capturing system having a first field of view, comprising the steps of: detecting speed data; generating first field of view depth data and/or object detection distance data; evaluating, based on said detected speed data, if a minimum field of view depth criteria and/or if a minimum object distance safety criteria is fulfilled; in case said minimum field of view depth criteria and/or said minimum object distance safety criteria is not fulfilled, combining first image capturing system image data with second image capturing system image data; evaluating based on said combined image data if a minimum field of view depth criteria and/or if a minimum object distance safety criteria is fulfilled; and depending on the evaluation if said criteria is fulfilled or not fulfilled, outputting and/or displaying safety data, said safety data being indicative if performing a certain vehicle maneuver is safe or not safe.

The afore mentioned method according to the first aspect can be configured to work with or in other aspects or embodiments of the invention as described in this document, including the use in an arrangement according to any of the aspects or embodiments as described in this document and including the use of the method in the form of a data processing program product according to any of the aspects or embodiments as described in this document.

According to a further aspect, the present invention provides a vehicle safety and/or driver assistance method, using image data from data connected—in particular camera-based—image capturing systems, in particular using image data from data connected rear view image capturing systems, mounted to at least one vehicle, in particular a method according to the first aspect of the invention, comprising the steps of: capturing image data using a first—in particular camera-based—image capturing system, in particular using a—in particular camera-based—rear view image capturing system; applying an artificial intelligence based and/or neuronal network based image evaluation algorithm on said image data to generate first field of view depth data and/or object detection distance data; evaluating if a minimum field of view depth criteria and/or if a minimum object distance criteria is fulfilled; in case said minimum field of view depth criteria and/or said minimum object distance criteria is not fulfilled, receiving second image data via a data connection from at least one second—in particular camera-based—image capturing system, in particular from at least one second—in particular camera-based—rear view image capturing system, having a second field of view; combining first image capturing system image data and second image capturing system image data; and automatically evaluating based on said combined image data if performing a certain vehicle maneuver is safe or not safe, in particular using a safety criteria evaluation software algorithm, in particular using an artificial intelligence based and/or neuronal network based safety criteria evaluation algorithm.

The afore mentioned method according to the second aspect can be configured to work with or in other aspects or embodiments of the invention as described in this document, including the use in an arrangement according to any of the aspects or embodiments as described in this document and including the use of the method in the form of a data processing program product according to any of the aspects or embodiments as described in this document.

According to an aspect of the invention, in a method according to the first or second aspect as described before, as well as for use in any other embodiment of the invention as described in this document, including in an embodiment in the form of a data processing program product, an artificial intelligence based and/or neuronal network based image evaluation algorithm AI comprises a machine learning model in the form of a neural network, in particular in the form of a transversal neural network and/or in the form of a convolutional neural network, correlated with a generative pre-trained transformer.

According to an aspect of the invention, in a method according to an aspect as described before, as well as for use in any other embodiment of the invention as described in this document, including in an embodiment in the form of a data processing program product, such method comprises the steps of: detecting speed limit data; correlating said detected speed limit data with detected first vehicle speed data; deriving safety criteria data, based on said correlated speed data; and correlating said safety criteria data with said field of view depth data and/or said object distance data.

According to an aspect of the invention, in a method according to an aspect as described before, as well as for use in any other embodiment of the invention as described in this document, including in an embodiment in the form of a data processing program product, such method comprises the steps of: capturing first image data from one first image capturing device or from a plurality of first image capturing devices comprised in said first image capturing system; and in case said minimum field of view depth criteria and/or said minimum object distance safety criteria is not fulfilled, capturing second image data from one second image capturing device or from a plurality of second image capturing devices comprised in said second image capturing system.

According to an aspect of the invention, in a method according to an aspect as described before, as well as for use in any other embodiment of the invention as described in this document, including in an embodiment in the form of a data processing program product, said safety criteria data bd, derived based on said correlated speed data, is minimum safety breaking distance data, in particular data representing a minimum safety breaking distance between a first vehicle in a first road lane and a further vehicle in the same road lane or in a different road lane, in particular a method and/or data adapted to avoid collision while a first vehicle is performing a vehicle maneuver to change from a first road lane to a different road lane.

According to an aspect of the invention, in a method according to an aspect as described before, as well as for use in any other embodiment of the invention as described in this document, including in an embodiment in the form of a data processing program product, such method comprises the steps of receiving in said first vehicle, in a first wireless communication unit comprised in said first vehicle, second image capturing system image data, transmitted by a second wireless communication unit comprised in a second vehicle.

According to an aspect of the invention, in a method according to the first or second aspect as described before, as well as for use in any other embodiment of the invention as described in this document, including in an embodiment in the form of a data processing program product, speed limit data is detected based on further image data, captured by a further image capturing device and/or based on digital map data, in particular based on further image data captured by a further image capturing device comprised in said first vehicle and/or based on digital map data stored in a data memory unit of said first vehicle.

According to a further aspect, the present invention provides a vehicle safety and/or driver assistance method using a first—in particular camera-based—rear view image capturing system having a first field of view, in particular a method according to any of the aspects as described before or comprising any of the features of any of the aspects as described before, as well as for use in any other embodiment of the invention as described in this document, including in an embodiment in the form of a data processing program product, such method comprises the steps of: capturing image data using said first—in particular camera-based—rear view image capturing system; detecting first vehicle speed data; applying a field of view depth detection algorithm and/or an object distance detection algorithm on said image data to generate first field of view depth data and/or object detection distance data; correlating said first vehicle speed data with said field of view depth data and/or said object distance data; evaluating from said correlation if a minimum field of view depth criteria and/or if a minimum object distance safety criteria is fulfilled; in case said minimum field of view depth criteria and/or said minimum object distance safety criteria is not fulfilled, receiving second image data using a second—in particular camera-based—rear view image capturing system having a second field of view; combining first—in particular camera-based—rear view image capturing system image data and second—in particular camera-based—rear view image capturing system image data; and evaluating based on said combined image data if a minimum field of view depth criteria and/or if a minimum object distance safety criteria is fulfilled; and depending on the evaluation if said criteria is fulfilled or not fulfilled, outputting and/or displaying safety data, said safety data being indicative if performing a certain vehicle maneuver is safe or not safe.

According to a further aspect, the present invention provides a vehicle safety and/or driver assistance arrangement, wherein the at least one image capturing system is a Camera Monitoring System (CMS), in particular a rear view Camera Monitoring System. Consequently, the image data are Camera Monitoring System image data.

According to a further aspect, the present invention provides vehicle safety and/or driver assistance arrangement, in particular adapted to implement a method according to any of the aspects as described before, such arrangement comprising: a first image capturing system, in particular a rear view image capturing system, having a first field of view; a speed data detection unit or a plurality of speed data detection units; an object distance detection module; a safety criteria data evaluation module; a wireless communication unit adapted to receive image data; an image data combining unit adapted to combine image data of a first image capturing system and at least one second or further image capturing system; and a safety data output interface being in data connection with said safety criteria data evaluation unit.

Such arrangement can be configured to perform a method according to any embodiment as described before, as well as to incorporate any of the technical features of any other embodiment of the invention as described in this document, and/or to execute an embodiment in the form of a data processing program product as described in this document.

According to a further aspect, the present invention provides vehicle safety and/or driver assistance arrangement, in particular adapted to implement a method according to any of the aspects as described before, such arrangement comprising: a first—in particular camera-based—rear view image capturing system having a first field of view; a first vehicle speed data detection unit; a first speed limit data detection unit; an object distance detection module comprising an artificial intelligence module; a safety criteria data evaluation module; a wireless communication unit adapted to receive image data; an image data combining unit adapted to combine image data of a first—in particular camera-based—rear view image capturing system and at least one second—in particular camera-based—rear view image capturing system or further image capturing system; and a safety data output interface being in data connection with said safety criteria data evaluation unit.

According to an aspect of the invention, in any of the aspects or arrangements as described before, as well as in the other embodiments of the invention as described in this document, said first image capturing system comprises a first image capturing device or a plurality of first image capturing devices.

Such afore mentioned arrangement can be configured to perform a method according to any embodiment as described before, as well as to incorporate any of the technical features of any other embodiment of the invention as described in this document, and/or to execute an embodiment in the form of a data processing program product as described in this document.

According to an aspect of the invention, in any of the aspects or arrangements as described before, as well as in the other embodiments of the invention as described in this document, said arrangement comprises a speed limit data detection unit adapted to detect speed limit data based on image data captured by an image capturing system and/or based on digital map data.

According to a further aspect, the present invention provides a data processing program product adapted for implementing a vehicle safety and/or driver assistance method according to any of the aspects as described before, comprising instructions which, when the program is executed by a data processing unit, cause the data processing unit to carry out program steps adapted to implement a method according to any of the aspects as described before, in particular in an arrangement according to any of the aspects as described before. Such afore mentioned data processing program product can be configured to perform a method according to any embodiment as described in this document, as well as to incorporate any of the technical features of any other embodiment of the invention as described in this document, and to be executed in any of the arrangements as described in this document.

According to a further aspect, the present invention provides a data processing program product adapted for implementing a vehicle safety and/or driver assistance method according to any of the aspects as described before, comprising instructions which, when the program is executed by a data processing unit, cause the data processing unit to carry out the following program steps, in particular according to a method according to any of the aspects as described before: a first program step of reading first image data from said first image capturing system; a second program step of reading object distance data from an object distance detection unit; a third program step of reading speed data from a speed data detection unit; a fourth program step of evaluating if a minimum safety criteria is fulfilled; a fifth program step of reading, in case said minimum safety criteria is not fulfilled, second image data from a first communication unit, in particular second image data being transmitted by a second communication unit which is in data connection with a second image capturing system; a sixth program step of combining said first image capturing system image data with second image capturing system image data; and a seventh program step of evaluating, based on said combined image data, if a minimum safety criteria is fulfilled; and an eighth program step of outputting and/or displaying safety data, depending on the evaluation if said criteria is fulfilled or not fulfilled.

Such afore mentioned data processing program product can be configured to perform a method according to any embodiment as described in this document, as well as to incorporate any of the technical features of any other embodiment of the invention as described in this document, and to be executed in any of the arrangements as described in this document.

According to a further aspect, the present invention provides a data processing program product adapted for implementing a vehicle safety and/or driver assistance method according to any of the aspects as described before, comprising instructions which, when the program is executed by a data processing unit, cause the data processing unit to carry out the following program steps, in particular according to a method according to any of the aspects as described before: a first program step of reading first image data from said first—in particular camera-based—rear view image capturing system; a second program step of reading object distance data from an object distance detection unit and/or of applying a field of view depth detection algorithm and/or of an object distance detection algorithm including an artificial intelligence algorithm implemented in a software-based artificial intelligence module on said image data to generate first field of view depth data and/or object detection distance data; a third program step of reading first vehicle speed data and/or speed limit data from a speed data detection unit or from a plurality of speed data detection units; a fourth program step of correlating said first vehicle speed data and/or speed limit data with said field of view depth data and/or said object distance data; a fifth program step of evaluating from said correlation if a minimum field of view depth criteria and/or if a minimum object distance safety criteria is fulfilled; a sixth program step of reading, in case said minimum safety criteria is not fulfilled, second image data from a first communication unit, in particular second image data being transmitted from a second communication unit which is in data connection with a second—in particular camera-based—rear view image capturing system; a seventh program step of combining first—in particular camera-based—rear view image capturing system image data and second—in particular camera-based—rear view image capturing system image data; an eighth program step of evaluating, based on said combined image data, if a minimum field of view depth criteria and/or if a minimum object distance safety criteria is fulfilled; and a ninth program step of outputting and/or displaying safety data, depending on the evaluation if said criteria is fulfilled or not fulfilled, said safety data being indicative if performing a certain vehicle maneuver (VM) is safe or not safe.

Such afore mentioned data processing program product can be configured to perform a method according to any embodiment as described in this document, as well as to incorporate any of the technical features of any other embodiment of the invention as described in this document, and to be executed in any of the arrangements as described in this document.

According to a further aspect, the present invention provides a data structure for use in a vehicle safety and/or driver assistance arrangement according to any of the aspects as described before and/or for use in a vehicle safety and/or driver assistance method according to any of the aspects as described before, in particular a data structure generated in a vehicle safety and/or driver assistance arrangement according to any the aspects as described before, and/or a data structure generated by a method according to any of the aspects as described before or by a method comprising any of or several of the features of any of the aspects as described before, such data structure comprising combined image data containing first image data generated by a first vehicle based image capturing system having a first field of view, and second image data generated by a second vehicle based image capturing system having a second field of view, such data structure and/or combined image data being adapted as input data for a vehicle based field of view depth detection and/or object distance detection unit; and/or such data structure and/or combined image data being adapted as input data for a vehicle based safety criteria evaluation unit.

The embodiments described above can be combined with each other as desired, if useful. Further possible embodiments, further configurations and implementations of the invention also include combinations, not explicitly mentioned, of features of the invention described herein with respect to the embodiments. In particular, the skilled person will thereby also add individual aspects as improvements or additions to the respective basic form of the present invention.

### BRIEF DESCRIPTION OF THE DRAWINGS

For a more comprehensive understanding of the invention and the advantages thereof, exemplary embodiments of the invention are explained in more detail in the following description with reference to the accompanying figures, in which like reference characters designate like parts and in which the following is shown:

FIG. 1 a schematic view of a first traffic situation with several vehicles with image capturing systems providing sufficient field of view depth;

FIG. 2 a schematic view of a second traffic situation with several vehicles with image capturing systems providing insufficient field of view depth;

FIG. 3 a schematic view of a third traffic situation with several vehicles with image capturing systems providing insufficient field of view depth because of visual obstructions;

FIG. 4 a schematic view of a fourth traffic situation with several vehicles with image capturing systems providing insufficient field of view depth because of visual obstructions caused by the shape of the road;

FIG. 5 a schematic view of a fifth traffic situation with several vehicles and with an alternative arrangement of image capturing systems providing insufficient field of view depth;

FIG. 6 a schematic view of a sixth traffic situation with several vehicles and with an alternative arrangement of image capturing systems providing insufficient field of view depth;

FIG. 7 a flow diagram of a first part of a specific embodiment of a vehicle safety and/or driver assistance method according to the invention;

FIG. 8 a flow diagram of a second part of a specific embodiment of a vehicle safety and/or driver assistance method according to the invention;

FIG. 9 a schematic depiction of a specific embodiment of a vehicle safety and/or driver assistance arrangement according to the invention;

FIG. 10 a schematic depiction of creation of a specific embodiment of a data structure combining image data of at least two image capturing systems according to the invention;

FIG. 11 a schematic flow diagram of a first specific embodiment of a data processing program product for implementing a vehicle safety and/or driver assistance method according to the invention; and

FIG. 12 a schematic flow diagram of a second specific embodiment of a data processing program product for implementing a vehicle safety and/or driver assistance method according to the invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of technology, except where specific meanings have otherwise been set forth herein.

### DETAILED DESCRIPTION OF EMBODIMENTS

In the future, assisted driving and/or automated driving will be increasingly linked to car-to-car communication and motorway assistants will in particular implement assisted and/or automated vehicle maneuvers such as an overtaking function from level 4 at the latest. The following embodiments of the invention explain in more detail how to autonomously assist and/or perform vehicle maneuvers such as an overtaking function with maximum safety. This topic may in particular implement the Co-programmed Partnership for Connected Automated Mobility (CCAM).

One problem of such afore mentioned scenarios of assisted driving and/or automated driving is: when overtaking, the decision whether to overtake is largely dependent on the depth of view of vehicle on-board image capturing systems, such as—in particular camera-based—rear view image capturing systems and/or—in particular camera-based—front view image capturing systems. Visibility plays a major role here. Only when objects can safely be detected and are within sufficient range may one start an overtaking maneuver. This applies to both autonomously driving decision-makers and assistance-based decision-makers. Even the pure rear view device or front view device can support decision making if the driver receives indications that he does not have sufficient visibility to the rear and/or to the front.

To solve this problem, on the one hand, images captured by vehicle on-board image capturing systems—in particular, as one possible embodiment of the invention, using camera-based image capturing systems—are evaluated via a software-based approach to determine how far a respective image capturing systems is able to look backwards and/or forward. This can be solved using technologies as described in the beginning with reference to the background of the invention. In particular, this problem can be solved by implementing an AI algorithm in such a way that the distance can be determined based on captured images or image sequences of one or several respective image capturing systems, in particular being determined on a pixel basis. In a second step, it can be determined whether—on the basis of the visibility determination—objects can be detected that are at a distance where a certain intended vehicle maneuver such as an overtaking is permitted, i.e. respective safety criteria for such vehicle maneuver are fulfilled. If this is not the case, the invention provides that the on-board vehicle automated and/or assisted driving system automatically looks for vehicles in the surrounding and within range of an on-board vehicle wireless communication unit, such as other connectable vehicles behind or in front of the own vehicle, and establishes a wireless data connection to respective image capturing systems being on board of such other vehicles, in order to get their rear view or front view information, which can be combined with image data captured by the image capturing system or image capturing systems being on board of the own vehicle. Since such a data connection to other on-board vehicle image capturing systems increases the range of vision to the rear or to the front due to one's own location, a range of vision extension is given on the basis of the received image data.

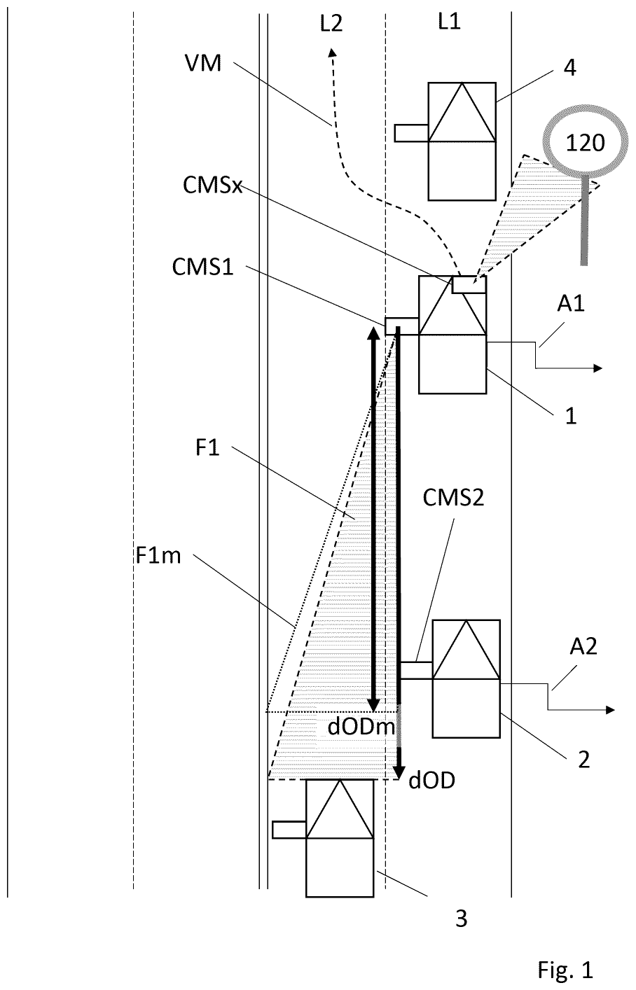

With reference to FIG. 1 of the drawings, a schematic view of a first traffic situation is depicted, with several vehicles 1, 2, 3, 4 driving on several adjacent road lanes L1, L2. One or several of the depicted vehicles 1, 2, 3, 4 are in particular equipped with camera-based image capturing systems CMS1, CMS2 mounted to at least one vehicle 1, 2, 3, 4. In FIG. 1, two vehicles 1, 2 are in particular equipped with at least one camera-based image capturing system CMS1, CMS2 per vehicle. Such camera-based image capturing systems CMS1, CMS2 in particular can be configured as or can be part of camera-based rear view image capturing systems CMS1, CMS2. In particular, the camera-based image capturing systems CMS1, CMS2 may be part of a so-called Camera Monitoring System (CMS).

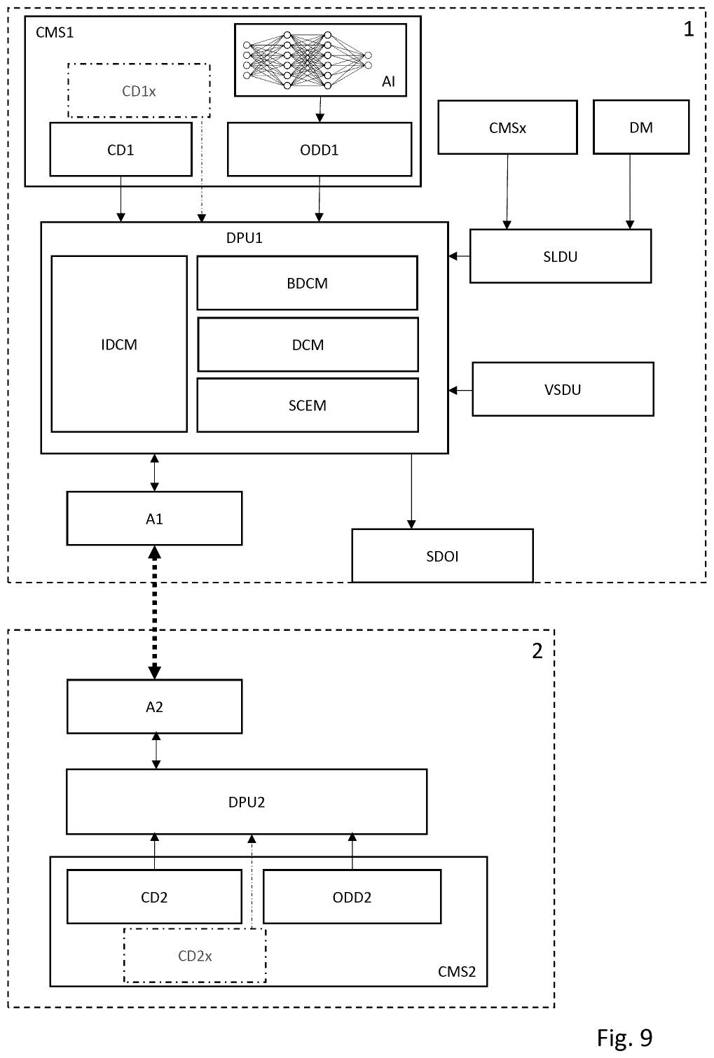

Each camera-based image capturing systems CMS1, CMS2 comprises at least one image capturing device CD1, CD2, in particular one camera device or comprises several image capturing devices CD1, CD1x, CD2, CD2x, in particular several camera devices, as will be explained in more detail with reference to FIG. 9.

The afore mentioned vehicle or vehicles 1, 2 carrying such camera-based image capturing systems CMS1, CMS2 also each comprise a wireless communication unit A1, A2, configured for wireless data transmission to respective other communication units A1, A2 of other vehicles 1, 2. Not all vehicles 1, 2, 3, 4 taking part in a traffic situation must be equipped with such afore mentioned camera-based image capturing systems CMS1, CMS2 and/or wireless communication units A1, A2.

As depicted in FIG. 1, a first camera-based image capturing system CMS1 of a first vehicle 1—in particular a first camera-based rear view image capturing system CMS1—has a first field of view (FoV) F1, and the depth of this first field of view F1 corresponds to a maximum distance for object detection dOD for which objects can still be detected within this first field of view F1 by the first camera-based image capturing system CMS1 of a first vehicle 1.

At least the first vehicle 1 further comprises a further camera-based image capturing system CMSx, in particular a further camera device, which is configured to detect speed limit data, in particular to detect and analyse traffic signs or other speed limit indication arrangements, as is schematically depicted in FIG. 1.

In the situation according to FIG. 1, it is assumed that the afore mentioned maximum distance for object detection dOD is bigger than a minimal distance for object detection dODm corresponding to a minimal first field of view F1m, both derived from or corresponding to minimal safety criteria, as will be explained in more detail in the following description and with respect to the following drawings.

As in the situation according to FIG. 1, a minimum safety criteria dODm is fulfilled, a certain vehicle maneuver VM is found to be safe for the first vehicle 1, in FIG. 1 in particular a maneuver to overtake a preceding vehicle 4 on the same road lane L1 by moving to the adjacent road lane L2, as the distance dOD to a detected vehicle 3 behind vehicle 1 driving on road lane L2 is bigger than said minimum safety criteria dODm.

This means in case there is significant visibility of relevant objects in the environment of a vehicle 1 carrying at least one camera-based image capturing system CMS1, to detect, analyze and confirm that certain safety criteria dODm are fulfilled, then additional data input for such decision and confirmation of fulfilment of safety criteria dODm is not required.

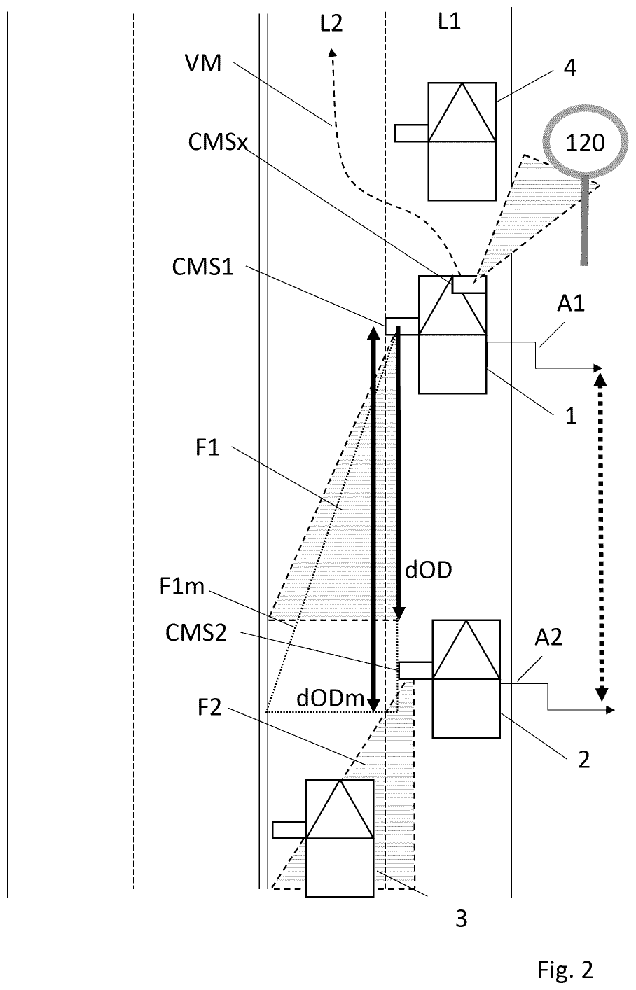

With reference to FIG. 2, a schematic view of a second traffic situation is depicted, where—similar to FIG. 1—several vehicles 1, 2, 3, 4 are driving on several adjacent road lanes L1, L2. Again, as in FIG. 1, several of the depicted vehicles 1, 2, 3, 4 are equipped with camera-based image capturing systems CMS1, CMS2 mounted to at least one vehicle 1, 2, 3, 4.

As depicted in FIG. 2, a first camera-based image capturing system CMS1 of a first vehicle 1 has again a first field of view F1. However, in the situation of FIG. 2, the depth of this first field of view F1, corresponding to a maximum distance for object detection dOD for which objects can still be detected within this first field of view F1 by the first camera-based image capturing system CMS1 of a first vehicle 1, is now smaller than a minimal distance for object detection dODm corresponding to a minimal first field of view F1m, both derived again from or corresponding to minimal safety criteria. In FIG. 2, this may be caused due to technical and/or optical limitations of the first camera-based image capturing system CMS1 and/or or due to distances being too big between the relevant vehicles 1, 2, 3, 4, and/or due to the relevant speeds and speed limits of the relevant vehicles 1, 2, 3, 4, as will be explained in more detail later.

Alternatively or in addition, insufficient field of view depth may be caused by visual obstructions VO in the area of the vehicle 1, as depicted in FIG. 2, and/or due to the distances between the relevant vehicles 1, 2, 3, 4, or due to the relevant speeds and speed limits of the relevant vehicles 1, 2, 3, 4.

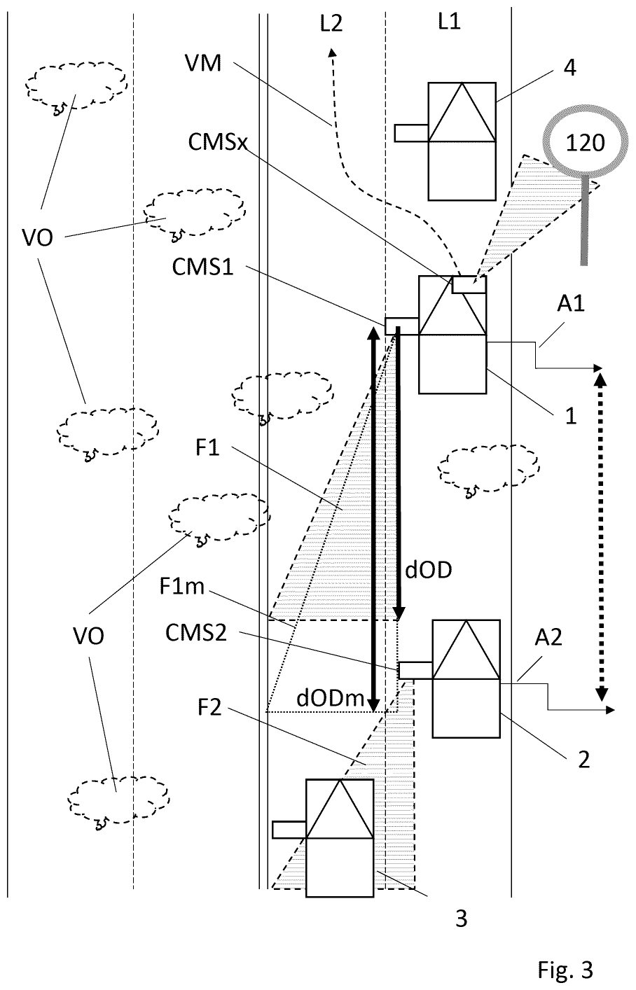

As depicted in FIG. 3, a first camera-based image capturing system CMS1 of a first vehicle 1 has again a first field of view F1. However in the situation of FIG. 3, due to the visual obstructions, which may be caused by environmental conditions such as weather conditions (such as rain, snow, fog), light conditions (such as darkness, shadows, glares) or other visual obstructions (such as smoke, dust), the depth of this first field of view F1, corresponding to a maximum distance for object detection dOD for which objects can still be detected within this first field of view F1 by the first camera-based image capturing system CMS1 of a first vehicle 1, is again smaller than a minimal distance for object detection dODm corresponding to a minimal first field of view F1m, both derived again from or corresponding to minimal safety criteria.

This means that in given traffic situations and with the given vehicle speed and speed limit conditions according to FIG. 2 or FIG. 3, the first camera-based image capturing system CMS1 of the first vehicle 1 provides insufficient field of view depth to detect relevant objects and to analyse and decide if safety criteria are fulfilled in order to safely perform an intended vehicle maneuver VM.

In such situation according to FIG. 2 or FIG. 3, the first wireless communication unit A1 of the first vehicle 1 establishes a wireless data connection and data exchange with a second wireless communication unit A2 of a second vehicle 2 within transmission range of the wireless communication unit A1, in order to receive image data captured by a second camera-based image capturing system CMS2 mounted to the second vehicle 2 having a second field of view F2, in particular from a second camera-based rear view image capturing system CMS2.

The received image data captured by a second camera-based image capturing system CMS2 mounted to the second vehicle 2 are used for virtually extending the field of view of the first second camera-based image capturing system CMS2 to ensure object detection and/or object distance detection in a sufficient distance range from first vehicle 1 to be able to decide if safety criteria are fulfilled in order to safely perform an intended vehicle maneuver VM, in particular a maneuver to overtake a preceding vehicle 4 on the same road lane L1 by moving to the adjacent road lane L2.

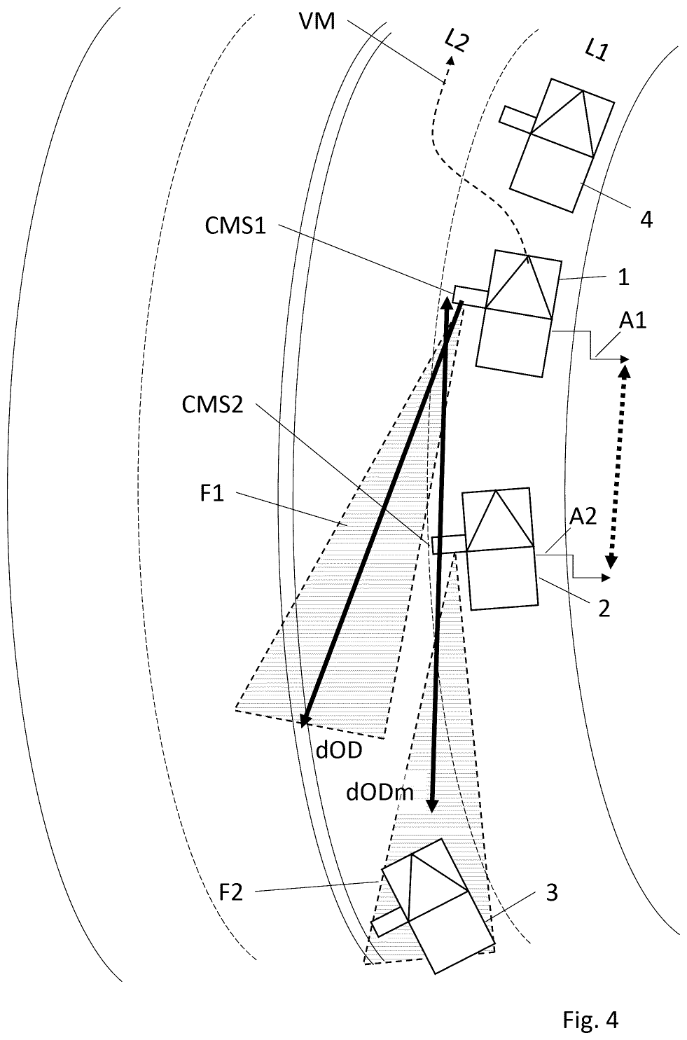

With reference to FIG. 4, a schematic view of a fourth traffic situation is depicted, where—similar to FIGS. 1 and 2—several vehicles 1, 2, 3, 4 are driving on several adjacent road lanes L1, L2. Again, as in FIG. 1, FIG. 2 and FIG. 3, several of the depicted vehicles 1, 2, 3, 4 are equipped with camera-based image capturing systems CMS1, CMS2 mounted to at least one vehicle 1, 2, 3, 4.

Again, similar to the situations of FIG. 2 and FIG. 3, the depth of the first field of view F1, corresponding to a maximum distance for object detection dOD for which objects can still be detected within this first field of view F1 by the first camera-based image capturing system CMS1 of a first vehicle 1, is smaller than a minimal distance for object detection dODm corresponding to a minimal first field of view F1m, both derived again from or corresponding to minimal safety criteria. In the situation according to FIG. 4, this is caused by visual obstructions due to curves of the road in area of the vehicle 1, which cause said visual obstruction for the first camera-based image capturing system CMS1 of the first vehicle 1.

This means that with the given shape of the road according to FIG. 4, the first camera-based image capturing system CMS1 of the first vehicle 1 has insufficient field of view depth to detect relevant objects such as vehicle 3 and to analyse and decide if safety criteria are fulfilled in order to safely perform an intended vehicle maneuver VM, in particular a maneuver to overtake a preceding vehicle 4 on the same road lane L1 by moving to the adjacent road lane L2.

To overcome this obstacle in the situation according to FIG. 4, again the first wireless communication unit A1 of the first vehicle 1 establishes a wireless data connection and data exchange with a second wireless communication unit A2 of a second vehicle 2 within transmission range of the wireless communication unit A1, in order to receive image data captured by a second camera-based image capturing system CMS2 mounted to the second vehicle 2 having a second field of view F2, in particular from a second camera-based rear view image capturing system CMS2.

Also, in the situation according to FIG. 4, the received image data captured by a second camera-based image capturing system CMS2 mounted to the second vehicle 2 are used for virtually extending the field of view of the first second camera-based image capturing system CMS2 to ensure object detection and/or object distance detection in a sufficient distance range from first vehicle 1 to be able to decide if safety criteria are fulfilled in order to safely perform an intended vehicle maneuver VM.

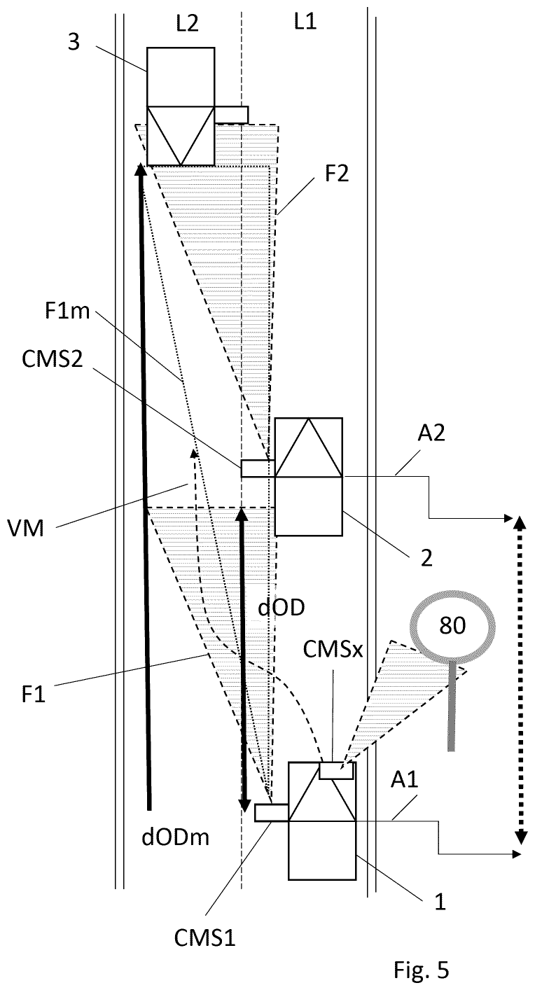

In FIG. 5, a fifth traffic situation is depicted with several vehicles 1, 2, 3 and with an alternative arrangement of image capturing systems CMS1, CMS2, providing insufficient field of view depth. A first camera-based image capturing system CMS1 of a first vehicle 1 has again a first field of view F1. However, in the arrangement of FIG. 5, this first camera-based image capturing system CMS1 of a first vehicle 1 is now directed into a forward direction, in particular being a first camera-based front view image capturing system CMS1, i.e. directed into the driving direction of vehicle 1, in contrast to each of the situations of FIG. 1 to FIG. 4, where a first camera-based image capturing system CMS1 of a first vehicle 1 is directed into a backward direction, i.e. opposite the driving direction of vehicle 1. In the situation of FIG. 5, the depth of the first field of view F1, corresponding to a maximum distance for object detection dOD for which objects can still be detected within this first field of view F1 by the first camera-based image capturing system CMS1 of a first vehicle 1, is again smaller than a minimal distance for object detection dODm corresponding to a minimal first field of view F1m, both derived again from or corresponding to minimal safety criteria. In FIG. 5, this may be caused due to technical and/or optical limitations of the first camera-based image capturing system CMS1 and/or or due to distances being too big between the relevant vehicles 1, 3, and/or due to the relevant speeds and speed limits of the relevant vehicles 1, 2, 3, as will be explained in more detail later.

To overcome this obstacle in the situation according to FIG. 5, again the first wireless communication unit A1 of the first vehicle 1 establishes a wireless data connection and data exchange with a second wireless communication unit A2 of a second vehicle 2 within transmission range of the wireless communication unit A1—here to a second vehicle 2 driving in front of first vehicle 1—, in order to receive image data captured by a second camera-based image capturing system CMS2 mounted to the second vehicle 2 having a second field of view F2, in particular from a second camera-based front view image capturing system CMS2.

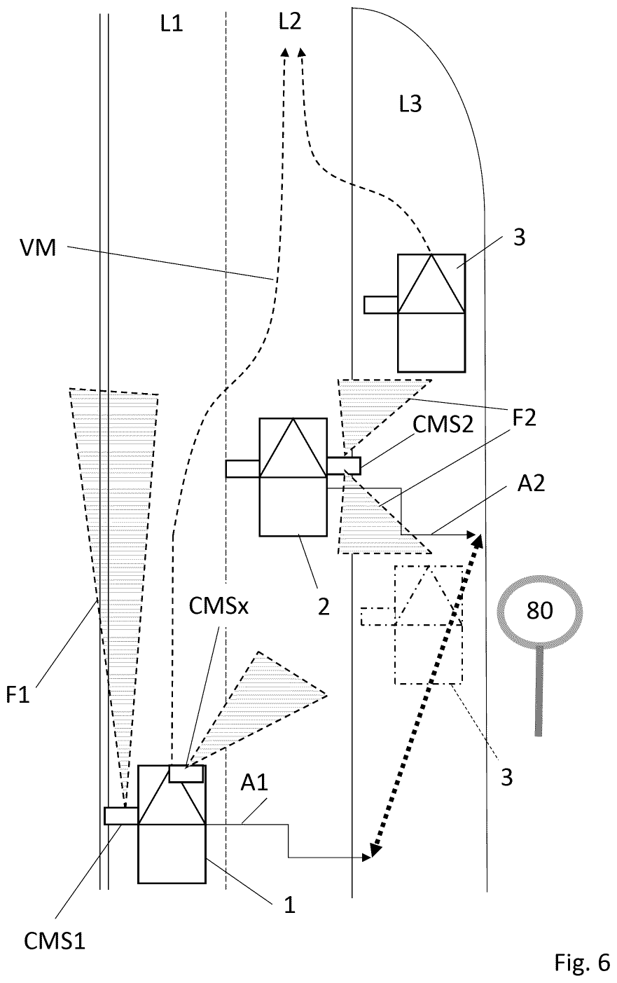

FIG. 6 depicts a schematic view of a sixth traffic situation with several vehicles and with an alternative arrangement of image capturing systems providing insufficient field of view depth, where the same reference signs as described with reference to FIG. 1 to FIG. 5 have the same or a similar meaning. Again, a traffic situation is depicted with several vehicles 1, 2, 3 and with an alternative arrangement of image capturing systems CMS1, CMS2, providing insufficient field of view depth. A first camera-based image capturing system CMS1 of a first vehicle 1 driving in a first road lane L1 has again a first field of view F1. In the arrangement of FIG. 6, this first camera-based image capturing system CMS1 of a first vehicle 1 is again directed into a forward direction, in particular being a first camera-based front view image capturing system CMS1, i.e. directed into the driving direction of vehicle 1. However, such first camera-based image capturing system CMS1 of a first vehicle 1 can in addition or alternatively be directed into a backward direction, i.e. opposite the driving direction of vehicle 1 as previously described. In the situation of FIG. 6, the direction and/or the depth of the first field of view F1 is again insufficient (smaller or directed in a different direction) to detect all relevant objects.

To overcome this obstacle in the situation according to FIG. 6, again the first wireless communication unit A1 of the first vehicle 1 establishes a wireless data connection and data exchange with a second wireless communication unit A2 of a second vehicle 2—which is driving in an adjacent road lane L2—within transmission range of the wireless communication unit A1—here to a second vehicle 2 driving in front of first vehicle 1—, in order to receive image data captured by a second camera-based image capturing system CMS2 mounted to the second vehicle 2 having a second field of view F2, in particular from a second camera-based front view image capturing system CMS2 and/or from a second camera-based rear view image capturing system CMS2. In the specific embodiment of FIG. 6, such second camera-based front and/or rear view image capturing system CMS2 is directed to an adjacent road lane L3 on the opposite side of the vehicle, i.e. to a road lane L3 opposite to the road lane L1 with respect to the (middle) road lane L3, to detect objects, i.e vehicles 3 that may cause a security risk or even a collision for vehicle 2 and other adjacent vehicles such as afore mentioned vehicle 1.

Such arrangement and method and/or respective data is again—similar to the situation of FIG. 1 to FIG. 5—adapted to avoid collision while a first vehicle 1 is performing a vehicle maneuver VM to change from a first road lane (L1) to a different road lane L2, L3, such as during the process of overtaking a vehicle, thereby moving to a different road lane L2 to initiate overtaking as previously shown, or moving back to the initial first road lane L1 to end the overtaking as shown in FIG. 6.

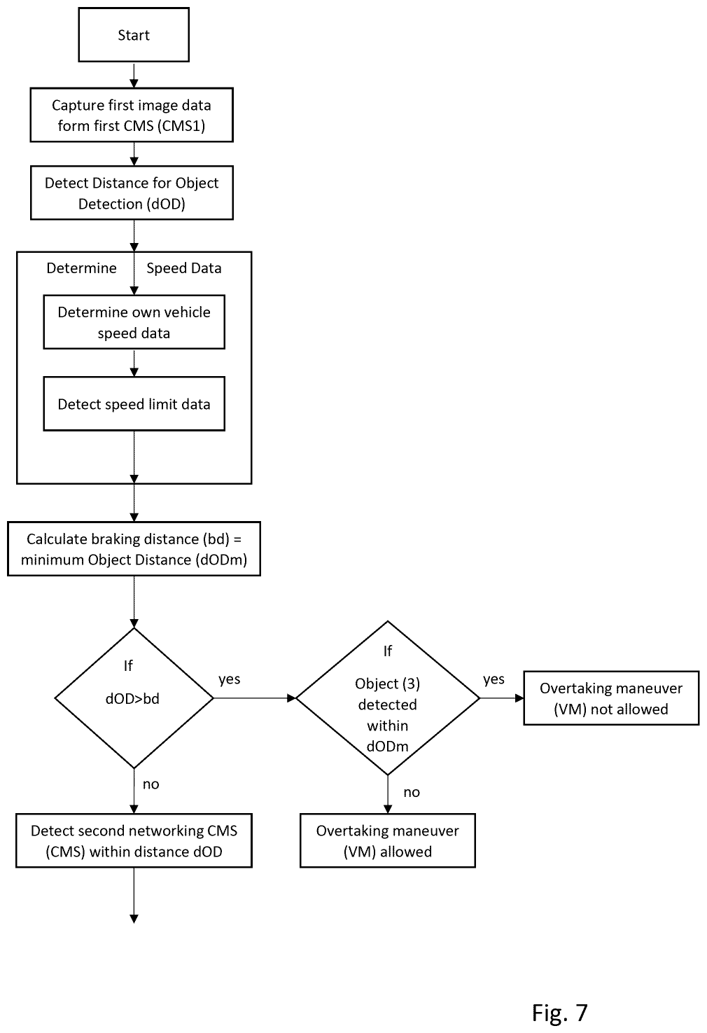

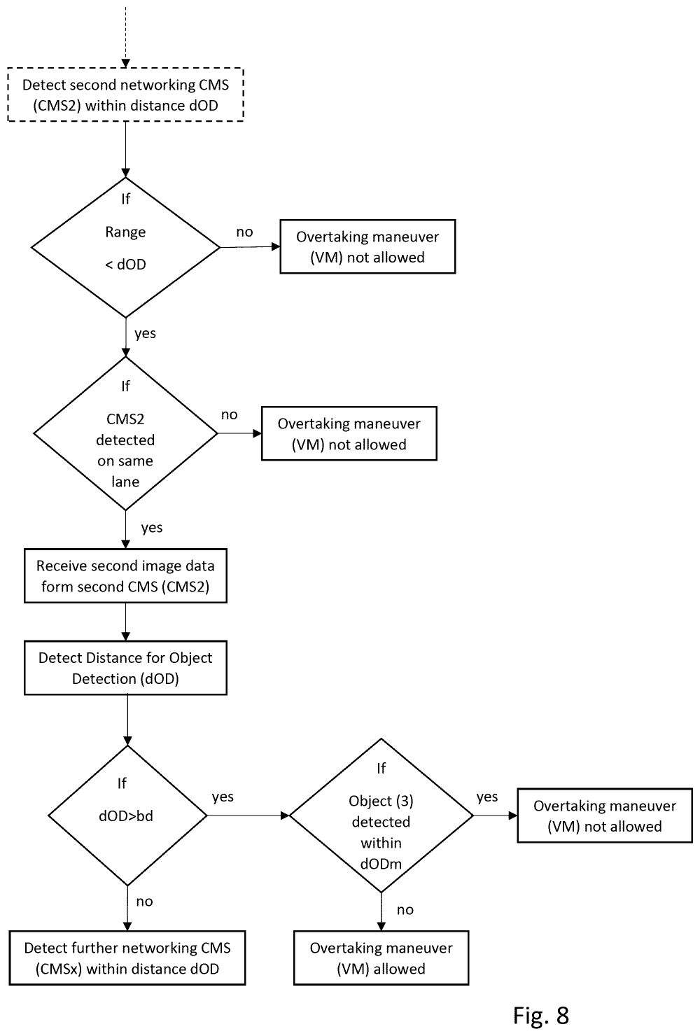

FIG. 7 depicts a flow diagram of a first part of a specific embodiment of a vehicle safety and/or driver assistance method according to the invention, and FIG. 8 depicts a flow diagram of a second part of a specific embodiment of a vehicle safety and/or driver assistance method according to the invention. The first part of a specific embodiment of a vehicle safety and/or driver assistance method according to the invention as shown in FIG. 7, my means of the example of a vehicle maneuver in the form of an overtaking maneuver, comprises the following steps:
Capture first image data form first CMS (CMS1)
Detect Distance for Object Detection (dOD)
Determine Speed Data, comprising the following steps:
   Determine own vehicle speed data
   Detect speed limit data
Calculate braking distance (bd)=minimum Object Distance (dODm)
Evaluate if Distance for Object Detection dOD>braking distance bd
   If the result of this first evaluation is positive=yes:
   Evaluate If an Object (3) is detected within minimum Object Distance dODm
      If the result of this second evaluation is positive=yes:
         Take the decision that overtaking maneuver (VM) not allowed
      If the result of this second evaluation is negative=no:
         Take the decision that overtaking maneuver (VMV) allowed
   If the result of the first evaluation is negative=no:
   Detect a second connectable image capturing system CMS2 of second, different vehicle 2 within Distance for Object Detection dOD

The second part of a specific embodiment of a vehicle safety and/or driver assistance method according to the invention as shown in FIG. 8, my means of the example of a vehicle maneuver in the form of an overtaking maneuver, comprises the following further steps:
Evaluate if the range of wireless data communication of on-board wireless communication unit A1<Distance for Object Detection dOD
   If the result of this third evaluation is negative=no:
   Take the decision that overtaking maneuver (VMV) not allowed
   If the result of this third evaluation is positive=yes:
   Evaluate if a connectable image capturing system CMS2 of second different vehicle 2 can be detected on the same road lane L1
      If the result of this fourth evaluation is negative=no:
      Take the decision that overtaking maneuver (VM) not allowed
      If the result of this fourth evaluation is positive=yes:
      Receive second image data form the second image capturing system CMS2 of second different vehicle 2
      Detect Distance for Object Detection (dOD) including received second image data form the second image capturing system CMS2 of second different vehicle 2
      Evaluate if Distance for Object Detection dOD>braking distance bd
      If the result of this fifth evaluation is positive=yes:
         Evaluate If an Object (3) is detected within minimum Object Distance dODm
         If the result of this sixth evaluation is positive=yes:
         Take the decision that overtaking maneuver (VM) not allowed
         If the result of sixth second evaluation is negative=no:
         Take the decision that overtaking maneuver (VM) allowed
      If the result of the fifth evaluation is negative=no:

Detect a further connectable image capturing system CMSx of a furhter, different vehicle within Distance for Object Detection dOD

In the following, a detailed example calculation of the afore mentioned specific embodiment of the invention, with reference to the afore mentioned Figures is described for an intended vehicle maneuver of overtaking a preceding vehicle 4:
Speed of first vehicle 1 (car on right lane L1): 80 km/h
Speed of vehicle 3 (car on left lane L2): 200 km/h
Differential speed between vehicle 1 and vehicle 3: 120 km/h
which means: 30 seconds/km
which results in a distance of 200 m in 6 seconds
which results in a required day and night visibility 200 m to enable overtaking.

The road visibility to the rear may be limited due to curves/night/rain/etc. to 170 m, as shown in FIG. 2, FIG. 3 and FIG. 4 respectively. So it is necessary to search for another, second vehicle 2 with networked camera-based image capturing system CMS2 within a range of at least 50 m and to establish a wireless data connection to such second vehicle 2.

Combining the image data of first vehicle 1 and second vehicle 2 by means of a wireless data connection results in a virtually extended field of view of at least

170m+50m=220 m.

This provides sufficient field of view range for the rear view of vehicle 1 and an overtaking procedure, i.e. a vehicle maneuver VM can be enabled if no object is visible in the overtaking lane L2 within a security range, which is derived from the current braking distance(s) of the respective relevant vehicle(s) 1, 3.

From the table below a skilled person can see how long the braking distance is. At a n absolute or relative (differential) speed of 120 km/h, the respective breaking distance would be 144 m. This calculation does not include a reaction time of the respective driver.

The braking distance can be calculated with the following formula:

Normal braking distance≈(speed travelled÷10)×(speed travelled÷10).

This results in the following braking distances:

| | |
|---|---|
| Speed | Single braking distance |

| | | | |
|---|---|---|---|
| 30 | km/h | 9 | m |
| 50 | km/h | 25 | m |
| 70 | km/h | 49 | m |
| 100 | km/h | 100 | m |
| 130 | km/h | 169 | m |

The visibility determination is based on a determination of speed data, which can include traffic sign recognition, as shown and explained with reference to FIG. 2 to FIG. 6. By comparing the own vehicle speed of first vehicle 1 and the maximum permitted speed derived from traffic sign recognition, a dynamic calculation is possible. Alternatively or in addition, speed data can be derived from digital map data, as shown and explained in the following description with reference to FIG. 9.

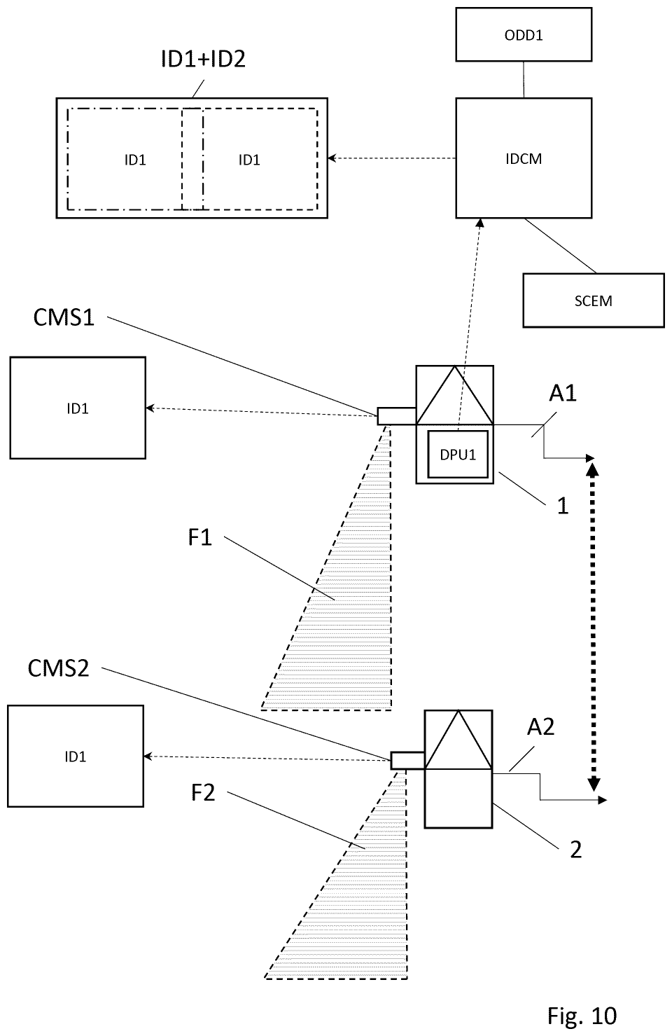

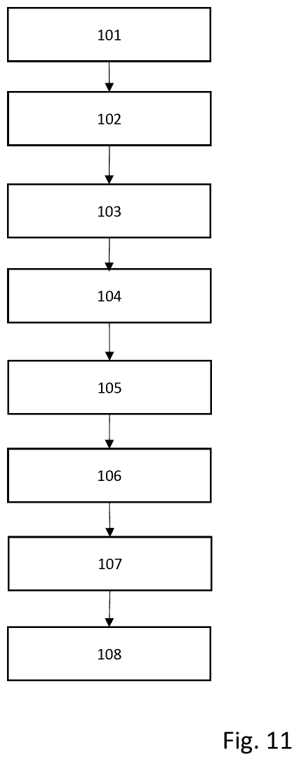

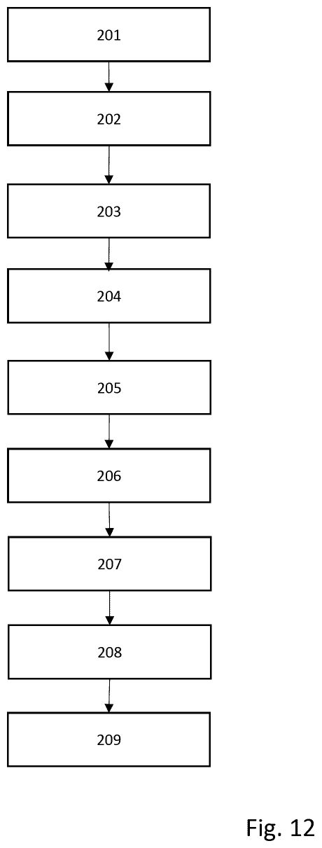

FIG. 9 depicts in a schematic way a specific embodiment of a vehicle safety and/or driver assistance arrangement according to the invention. In particular, FIG. 7 schematically shows functional elements, units and modules of a vehicle safety and/or driver assistance arrangement, in particular adapted to implement a method as described with reference to FIG. 7 and FIG. 8 and/or as described with reference to the following description and FIG. 10 and/or FIG. 11 and/or FIG. 12. The afore mentioned functional elements, units and modules can be implemented as hardware elements, units and modules or can be implemented a software elements, units and modules or as a combination of both, hardware and software.

The specific embodiment according to FIG. 9 comprises a vehicle safety and/or driver assistance arrangement of a first vehicle 1, comprising at least the following functional elements, units and/or modules: a first image capturing system CMS1 having a first field of view F1 as shown in FIG. 1 to FIG. 6; a first object distance detection unit ODD1 which can be comprised in a first image capturing system CMS1 or alternatively can be comprised in a first data processing unit DPU1 of vehicle 1; at least one second or further image capturing system CD11; a plurality of speed data detection units SLDU, VSDU; a first data processing unit DPU1 of vehicle 1; an image data combining unit IDCM adapted to combine image data of a plurality of image capturing systems CMS1, CMS2, CMSx; a breaking distance calculation module BDCM; a distance comparing module DCM; a safety criteria data evaluation module SCEM; a first wireless communication unit A1 adapted to receive image data; and a safety data output interface SDOI being in data connection with said safety criteria data evaluation unit SCEM.

The first image capturing system CMS1 can comprise one first image capturing device CD1 or a plurality of first image capturing devices CD1, CD1x, in particular image capturing devices CD1, CD1x implemented as camera devices, in particular as camera-based rear view devices and/or as camera-based front view devices. The plurality of speed data detection units SLDU, VSDU can in particular comprise a first vehicle speed data detection unit VSDU and a first speed limit data detection unit SLDU. Said speed limit data detection unit SLDU can be adapted to detect speed limit data based on image data captured by an image capturing system CMSx being in data connection with said speed limit data detection unit SLDU and/or based on digital map data DM, such digital map data DM being stored in a digital map data DM memory unit being in data connection with said speed limit data detection unit SLDU.

The first object distance detection unit ODD1 can comprise an artificial intelligence module AI, in particular an artificial intelligence according to a technology as described before in the background of the invention, that can comprise a software-implemented AI algorithm which can comprise a machine learning model in the form of a neural network, in particular in the form of a transversal neural network and/or in the form of a convolutional neural network, correlated with a generative pre-trained transformer that uses special algorithms to find patterns in data sequences, in particular in image data representing images captured by one or several vehicle on-board image capturing systems and/or in image data representing sequences of images captured by one or several vehicle on-board image capturing systems.

The specific embodiment according to FIG. 9 also shows functional elements, units and/or modules of a further, second vehicle 2 being in wireless data connection with the afore mentioned first vehicle 1, in particular functional elements, units and/or modules of a further, second a vehicle safety and/or driver assistance arrangement of a second vehicle 2, comprising at least the following functional elements, units and/or modules: a second image capturing system CMS2 having a second field of view F2 as shown in FIG. 1 to FIG. 6; a second object distance detection unit ODD2 which can be comprised in a second image capturing system CMS2 or alternatively can be comprised in a second data processing unit DPU2 of vehicle 2; a second data processing unit DPU2 of vehicle 2; and a second wireless communication unit A2 adapted to transmit image data.

The second image capturing system CMS2 can comprise one second image capturing device CD2 or a plurality of second image capturing devices CD2, CD2x, in particular image capturing devices CD2, CD2x implemented as camera devices, in particular as camera-based rear view devices and/or as camera-based front view devices. The second object distance detection unit ODD2 also can comprise an artificial intelligence module AI (not shown in FIG. 9), that can comprise a software-implemented AI algorithm, in particular an artificial intelligence according to a technology as described before in the background of the invention, which can comprise a machine learning model in the form of a neural network, in particular in the form of a transversal neural network and/or in the form of a convolutional neural network, correlated with a generative pre-trained transformer that uses special algorithms to find patterns in data sequences, in particular in image data representing images captured by one or several vehicle on-board image capturing systems and/or in image data representing sequences of images captured by one or several vehicle on-board image capturing systems.

Thus, FIG. 9 in particular schematically depicts a specific embodiment of vehicle safety and/or driver assistance arrangement according to the invention, adapted to implement a method according to FIGS. 7 and 8, comprising:
a first camera-based rear view image capturing system CMS1 having a first field of view F1;
a first vehicle speed data detection unit VSDU;
a first speed limit data detection unit SLDU;
an object distance detection unit ODD1;
a safety criteria data evaluation unit SCEM;
a wireless communication unit A1 adapted to receive image data;
an image data combining unit IDCM adapted to combine image data of a first camera-based rear view image capturing system CMS1 and at least one second camera-based rear view image capturing system or further image capturing system CMS2, CD11; and
a safety data output interface SDOI being in data connection with said safety criteria data evaluation unit SCEM; wherein
said first image capturing system CMS1 comprises a first image capturing device CD1 or a plurality of first image capturing devices CD1, CD1x; and
said vehicle safety and/or driver assistance arrangement further comprises a speed limit data detection unit SLDU adapted to detect speed limit data based on image data captured by an image capturing device CMSx and/or based on digital map data DM.

FIG. 10 schematically depicts the creation of a specific embodiment of a data structure combining first image data ID1 and second image data ID2 of at least two image capturing systems CMS1, CMS2 of at least two vehicles 1, 2 according to the invention, using a wireless data connection based on respective wireless communication units A1, A2 of the vehicles 1, 2. Said data structure comprises combined image data ID1+ID2 containing image data generated by a first vehicle based image capturing system CMS1 having a first field of view F1 and image data generated by a second vehicle based image capturing system CMS2 having a second field of view F2, such data structure and/or combined image data ID1+ID2 being adapted as input data for a vehicle based field of view F1, F2 depth detection and/or object distance detection unit ODD1, ODD2, and/or such data structure and/or combined image data ID1+ID2 being adapted as input data for a vehicle based safety criteria evaluation unit SCEM, each of which can be in data connection with a image data combining module IDCM adapted to create such data structure and/or combined image data ID1+ID2 and such image data combining module IDCM being implemented in a first data processing unit DPU1 of said first vehicle 1 as software implemented module or as hardware implemented module.

Such data structure can in particular comprise an image content data block of combined image data ID1+ID2, the size of said data block of combined image data ID1+ID2 being smaller than the sum of the size of a first data block comprising content image of said first image data ID1 and of a second data block comprising image content of said second image data ID2. Such data structure can in particular comprise in addition data derived from first field of view F1 data of said first image capturing system CMS1 and data derived from second field of view F2 data of said second image capturing system CMS2.

FIG. 11 depicts a schematic flow diagram of a first specific embodiment of a data processing program product for implementing a vehicle safety and/or driver assistance method according to the invention. The data processing program product as depicted in FIG. 11 can be adapted for implementing a vehicle safety and/or driver assistance method using a first image capturing system CMS1 having a first field of view F1 as shown in the figures described before. Said data processing program product comprises instructions which, when the program is executed by a data processing unit DPU1 of a vehicle 1, cause the data processing unit DPU1 to carry out the following program steps:
a first program step 101 of reading first image data from said first image capturing system CMS1 of vehicle 1;
a second program step 102 of reading object distance data from an object distance detection unit ODD1 of vehicle 1;
a third program step 103 of reading speed data from a speed data detection unit SLDU, VSDU;
a fourth program step 104 of evaluating if a minimum safety criteria bd and/or dODm as described before is fulfilled;
a fifth program step 105 of reading, in case said minimum safety criteria bd and/or dODm is not fulfilled, second image data from a first communication unit A1 of vehicle 1, in particular second image data being transmitted by a second communication unit A2 of a second vehicle 2 which is in data connection with a second image capturing system CMS2 of said second vehicle 2;
a sixth program step 106 of combining said first image capturing system CMS1 image data ID1 with second image capturing system CMS2 image data ID2 to create combined image data ID1+ID2 and in particular a data structure comprising such combined image data ID1+ID2; and
a seventh program step 107 of evaluating, based on said combined image data, if a minimum safety criteria bd, dODm as described before is fulfilled; and
an eighth program step 108 of outputting and/or displaying safety data, depending on the evaluation if said criteria bd, dODm is fulfilled or not fulfilled.

FIG. 12 depicts a schematic flow diagram of a second specific embodiment of a data processing program product for implementing a vehicle safety and/or driver assistance method according to the invention. The data processing program product as depicted in FIG. 12 can be adapted for implementing a vehicle safety and/or driver assistance method using a first image capturing system CMS1 having a first field of view F1 as shown in the figures described before. Said data processing program product comprises instructions which, when the program is executed by a data processing unit DPU1 of a vehicle 1, cause the data processing unit DPU1 to carry out the following program steps:
a first program step 201 of reading first camera-based rear view image capturing system CMS1;
a second program step 202 of reading object distance data from an object distance detection unit ODD1 and/or of applying a field of view F1 depth detection algorithm and/or of an object distance dOD detection algorithm on said image data, one of or each of such afore mentioned algorithm in particular including an artificial intelligence algorithm as already described in this document and implemented in a software-based artificial intelligence module AI, to generate first field of view F1 depth data and/or object detection distance dOD data, wherein said AI algorithm implemented in the course of the invention can be designed to include a generative pre-trained transformer that uses dedicated algorithms to find patterns in image data and/or image data sequences, in particular in image data representing images captured by one or several vehicle on-board image capturing systems and/or in image data representing sequences of images captured by one or several vehicle on-board image capturing systems, i.e. such AI algorithm comprising a machine learning model in the form of a neural network, in particular in the form of a transversal neural network and/or in the form of a convolutional neural network, correlated with a generative pre-trained transformer;
a third program step 203 of reading first vehicle 1 speed data and/or speed limit data from a speed data detection unit SLDU, VSDU or from a plurality of speed data detection units SLDU, VSDU;
a fourth program step 204 of correlating said first vehicle 1 speed data and/or speed limit data with said field of view F1 depth data and/or said object distance dOD data;
a fifth program step 205 of evaluating from said correlation if a minimum field of view F1 depth criteria and/or if a minimum object distance dODm safety criteria is fulfilled;
a sixth program step 206 of reading, in case said minimum safety criteria bd, dODm is not fulfilled, second image data from a first communication unit A1, in particular second image data being transmitted from a second communication unit A2 which is in data connection with a second camera-based rear view image capturing system CMS2;
a seventh program step 207 of combining first camera-based rear view image capturing system CMS1 image data and second camera-based rear view image capturing system CMS2 image data; an eighth program step 208 of evaluating, based on said combined image data, if a minimum field of view F1, F2 depth criteria and/or if a minimum object distance dODm safety criteria is fulfilled based on the combined image data ID1+ID2; and
a ninth program step 209 of outputting and/or displaying safety data, depending on the evaluation if said criteria dODm is fulfilled or not fulfilled, said safety data being indicative if performing a certain vehicle maneuver VM is safe or not safe.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus.

Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF REFERENCE SIGNS

1 first vehicle
2 second vehicle
3 third vehicle
4 fourth vehicle
A1 first wireless communication unit
A2 second wireless communication unit
AI artificial intelligence module
bd breaking distance
BDCM breaking distance calculation module
CD1 first image capturing device
CD1x further first image capturing device
CD2 second image capturing device
CD2x further second image capturing device
CMS1 first image capturing system
CMS2 second image capturing system
CMSx further image capturing system
DCM distance comparing module
dOD distance for object detection
dODm minimal distance for object detection
DPU1 first data processing unit
DPU2 second data processing unit
DM digital map
ID1 first image data
ID2 second image data
ID1+ID2 combined image data
IDCM image data combining module
F1 first field of view
F2 second field of view
L1 first lane
L2 second lane
ODD1 object distance detection module
SCEM safety criteria evaluation module
SLDU speed limit detection unit
VM vehicle maneuver
VO visual obstruction
VSDU vehicle speed detection unit

1. A vehicle safety and/or driver assistance method, using a first image capturing system having a first field of view, the method comprising:
detecting speed data;
generating first field of view depth data and/or object detection distance data;
evaluating, based on said detected speed data, if a minimum field of view depth criteria and/or if a minimum object distance safety criteria is fulfilled;
in case said minimum field of view depth criteria and/or said minimum object distance safety criteria is not fulfilled, combining first image capturing system image data with second image capturing system image data;
evaluating based on said combined image data if a minimum field of view depth criteria and/or if a minimum object distance safety criteria is fulfilled; and
depending on the evaluation if said criteria is fulfilled or not fulfilled, outputting and/or displaying safety data, said safety data being indicative if performing a certain vehicle maneuver is safe or not safe.

2. The method of claim 1, the method further comprising:
capturing image data using a first image capturing system;
applying an artificial intelligence based and/or neuronal network based image evaluation algorithm on said image data to generate first field of view depth data and/or object detection distance data;
evaluating if a minimum field of view depth criteria and/or if a minimum object distance criteria is fulfilled;
in case said minimum field of view depth criteria and/or said minimum object distance criteria is not fulfilled, receiving second image data via a data connection from at least one second image capturing system having a second field of view;
combining first image capturing system image data and second image capturing system image data;
and automatically evaluating based on said combined image data if performing a certain vehicle maneuver is safe or not safe, in particular using a safety criteria evaluation software algorithm, in particular using an artificial intelligence based and/or neuronal network based safety criteria evaluation algorithm.

3. The method of claim 1, wherein an artificial intelligence based and/or neuronal network based image evaluation algorithm comprises a machine learning model in the form of a neural network, in particular in the form of a transversal neural network and/or in the form of a convolutional neural network, correlated with a generative pre-trained transformer.

4. The method of claim 1, further comprising:
detecting speed limit data;
correlating said detected speed limit data with detected first vehicle speed data;
deriving safety criteria data, based on said correlated speed data; and
correlating said safety criteria data with said field of view depth data and/or said object distance data;
in particular comprising steps wherein: speed limit data is detected based on further image data, captured by a image capturing device and/or based on digital map data,
in particular based on further image data captured by a image capturing device comprised in said first vehicle and/or based on digital map data stored in a data memory unit of said first vehicle.

5. The method of claim 1, further comprising:
capturing first image data from one first image capturing device or from a plurality of first image capturing devices comprised in said first image capturing system; and
in case said minimum field of view depth criteria and/or said minimum object distance safety criteria is not fulfilled, capturing second image data from one second image capturing device or from a plurality of second image capturing devices comprised in said second image capturing system;
in particular further comprising the steps of: receiving in said first vehicle, in a first wireless communication unit comprised in said first vehicle, second image capturing system image data, transmitted by a second wireless communication unit comprised in a second vehicle.

6. The method of claim 1,
wherein said safety criteria data, derived based on said correlated speed data, is minimum safety breaking distance data,
in particular data representing a minimum safety breaking distance between a first vehicle in a first road lane and a further vehicle in the same road lane or in a different road lane.

7. The method of claim 1, wherein the method and/or data is further adapted to avoid collision while a first vehicle is performing a vehicle maneuver to change from a first road lane to a different road lane.

8. The method of claim 1, the method further comprising:
capturing image data using said first rear view image capturing system;
detecting first vehicle speed data;
applying a field of view depth detection algorithm and/or an object distance detection algorithm on said image data to generate first field of view depth data and/or object detection distance data;
correlating said first vehicle speed data with said field of view depth data and/or said object distance data;
evaluating from said correlation if a minimum field of view depth criteria and/or if a minimum object distance safety criteria is fulfilled;
in case said minimum field of view depth criteria and/or said minimum object distance safety criteria is not fulfilled, receiving second image data using a second rear view image capturing system having a second field of view;
combining first rear view image capturing system image data and second rear view image capturing system image data; and
evaluating based on said combined image data if a minimum field of view depth criteria and/or if
a minimum object distance safety criteria is fulfilled; and
depending on the evaluation if said criteria is fulfilled or not fulfilled, outputting and/or displaying safety data, said safety data being indicative if performing a certain vehicle maneuver is safe or not safe.

9. The method of claim 1, wherein the at least one image capturing system is a Camera Monitoring System, in particular a rear view Camera Monitoring System, and wherein the image data are Camera Monitoring System image data.

10. A vehicle safety and/or driver assistance arrangement, the arrangement comprising:
a first image capturing system having a first field of view;
at least one speed data detection unit;
an object distance detection module;
a safety criteria data evaluation module;
a wireless communication unit adapted to receive image data;
an image data combining unit adapted to combine image data of the first image capturing system and at least one second image capturing system; and
a safety data output interface being in data connection with said safety criteria data evaluation unit.

11. The arrangement of claim 10, the arrangement comprising:
a first rear view image capturing system having a first field of view;
a first vehicle speed data detection unit;
a first speed limit data detection unit;
an object distance detection module comprising an artificial intelligence module;
a safety criteria data evaluation module;
a wireless communication unit adapted to receive image data;
an image data combining unit adapted to combine image data of the first rear view image capturing system and at least one second rear view image capturing system; and
a safety data output interface being in data connection with said safety criteria data evaluation unit.

12. The arrangement of claim 10, wherein said first image capturing system comprises at least one first image capturing devices.

13. The arrangement of claim 10, further comprising a speed limit data detection unit adapted to detect speed limit data based on image data captured by an image capturing system and/or based on digital map data.

14. The arrangement of claim 10, wherein the at least one image capturing system is a Camera Monitoring System, in particular a rear view Camera Monitoring System.

15. Data processing program product, adapted for implementing a vehicle safety and/or driver assistance method using a first image capturing system, in particular using a rear view image capturing system, having a first field of view, comprising instructions which, when the program is executed by a data processing unit, cause the data processing unit to carry out the following program steps:
a first program step of reading first image data from said first image capturing system;
a second program step of reading object distance data from an object distance detection unit;
a third program step of reading speed data from a speed data detection unit;
a fourth program step of evaluating if a minimum safety criteria is fulfilled;
a fifth program step of reading, in case said minimum safety criteria is not fulfilled, second image data from a first communication unit, in particular second image data being transmitted by a second communication unit which is in data connection with a second image capturing system;
a sixth program step of combining said first image capturing system image data with second image capturing system image data; and
a seventh program step of evaluating, based on said combined image data, if a minimum safety criteria is fulfilled; and
an eighth program step of outputting and/or displaying safety data, depending on the evaluation if said criteria is fulfilled or not fulfilled.
